(19) United States
(12) Patent Application Publication
(10) Pub. No.: US 2026/0196137 A1
(43) Pub. Date: Jul. 9, 2026

(54) INTERACTIVE LEARNING BOARD SYSTEM AND METHOD THEREOF

(71) Applicants: Anil Kumar Hastir, SAS Nagar (IN); Lalita Kumari, Tehsil-Anni (IN)

(72) Inventors: Anil Kumar Hastir, SAS Nagar (IN); Lalita Kumari, Tehsil-Anni (IN)

(21) Appl. No.: 19/171,291

(22) Filed: Apr. 6, 2025

(30) Foreign Application Priority Data
Jan. 9, 2025 (IN) 202511002240

(51) Int. Cl. G09B 1/08; G01B 7/31; G09B 5/02

(52) U.S. Cl. CPC G09B 1/08; G01B 7/31; G09B 5/02

(57) ABSTRACT

An interactive learning board system (100) is designed to teach the alphabet in multiple languages. It consists of a foundation pad (102) with a cavity (110) and embedded sensors (112a-112n). The system features a set of interchangeable layers (104a-104n), each corresponding to a different language, with cutouts (114a-114n) for letters or symbols of that language's alphabet. The layers are positioned accurately using an alignment mechanism (116). A set of magnetic pegs (106a-106n) represents the letters or symbols, and the embedded sensors detect their placement on the layers. These sensors assess the alignment of the pegs, with positive or negative status values indicating correct or incorrect placement. A communication unit (108) transmits data to an external application, providing real-time feedback based on the peg placement. Together, the foundation pad, interchangeable layers, and magnetic pegs enable interactive, real-time language learning.

### CROSS-REFERENCE TO RELATED APPLICATIONS

This application claims priority to IN 202511002240, filed on Jan. 9, 2025. The contents of the above-referenced application are hereby incorporated by reference in their entirety.

### TECHNICAL FIELD

The present disclosure relates generally to interactive learning. More specifically, the present disclosure relates to an interactive learning board system and a method thereof.

### BACKGROUND

Traditional alphabet puzzles are educational toys designed to help young children learn and recognize the letters of the alphabet in an interactive way. These puzzles typically consist of individual letter-shaped pieces, representing the entire alphabet from A to Z. The pieces fit into corresponding slots or boards, often with the letter printed or illustrated beneath each slot to provide a visual cue. The designs are usually colorful, incorporating bright hues and engaging illustrations to capture children's attention and stimulate learning. Some puzzles also include additional features such as pictures of objects that begin with the corresponding letter (for example, “A” with an apple), textures, or sounds to enhance sensory learning and make the experience more immersive. Despite their educational benefits, traditional alphabet puzzles have several limitations. One of the major drawbacks is their single-language focus. These puzzles are typically designed for one language, most commonly English, limiting children's exposure to other languages during an important period of language development. Additionally, the content of traditional puzzles is static, meaning it cannot be easily changed or updated, which can reduce long-term engagement and adaptability as the child's learning needs evolve. The puzzles also have a limited scope, focusing primarily on letter recognition without integrating broader linguistic or cultural education, which could provide a more well-rounded learning experience. Furthermore, they lack personalization options, meaning they are not customizable to accommodate different learning paces or individual interests.

Dynamic content alphabet puzzles were developed to address some of the limitations of traditional puzzles by introducing a level of content interchangeability. These puzzles feature interchangeable slots that allow different content pieces to be inserted, enabling some degree of flexibility. Certain designs also include central cavities where new content sheets, such as different sets of letters, can be slid in, providing a way to introduce new material. While these puzzles offer more flexibility than traditional puzzles, they still come with their own set of challenges. For instance, they are often still language-specific, typically supporting only one language at a time despite the ability to change content sheets. Moreover, creating new content sheets is often not user-friendly or practical for personalized learning, limiting their overall usefulness. Another limitation of dynamic content puzzles is the complexity involved in switching content. Changing the puzzle's content is not always seamless and can disrupt the learning experience. This issue may hinder the flow of learning and make the system less engaging for children. Furthermore, while dynamic puzzles allow for some content change, they still do not adequately address the need for learning multiple languages simultaneously, which is especially important in multilingual societies. The lack of multilingual support means that these puzzles may not fully meet the needs of children growing up in environments where exposure to multiple languages is essential for cognitive development. Existing technologies in both traditional and dynamic content alphabet puzzles share several key problems that limit their effectiveness. One of the most significant issues is their single-language focus. Most puzzles are designed for just one language, often English, which limits children's exposure to other languages during a critical period of language acquisition. This is especially problematic in multilingual societies, where children could benefit from learning multiple languages at once to foster cognitive flexibility and communication skills. Additionally, both traditional and dynamic puzzles suffer from static or non-customizable content, making it difficult to adapt the material to the child's evolving learning needs or personal interests. As a result, engagement may decrease over time, and the learning experience becomes less effective. Another problem with existing alphabet puzzles is the lack of interactivity and personalization. Many puzzles do not accommodate different learning paces, styles, or cultural backgrounds, which can create barriers to effective learning. The absence of personalization can increase the affective filter, a psychological barrier that hinders language acquisition due to negative emotions like boredom or frustration. Additionally, current puzzles often miss opportunities to promote cultural awareness, which could help foster an appreciation for diversity and global citizenship. Finally, some educational tools have introduced electronic components to enhance interactivity, which can increase screen time an issue that raises concerns about children's health and development. This dependency on screen time can detract from the benefits of hands-on, tactile learning experiences.

Thus, there is a need for a technical solution that overcomes the aforementioned problems of conventional language learning techniques.

### SUMMARY

Disclosed is an interactive learning board system for learning the alphabet of multiple languages. The interactive learning board system comprising a foundation pad, a plurality of interchangeable layers, a plurality of magnetic pegs, and a communication unit. The foundation pad includes a cavity and embedded sensors. Each interchangeable layer corresponds to a language of the multiple languages. Each interchangeable layer comprising a plurality of cutouts and an alignment mechanism. Each cutout corresponds to one of a letter or a symbol of the alphabet of the language. The alignment mechanism is configured to facilitate correct positioning within the cavity. Each peg represents the letter or the symbol. The embedded sensors are configured to detect the placement of the plurality of magnetic pegs on each interchangeable layer. The embedded sensors are further configured to facilitate determining an alignment status of the plurality of magnetic pegs. The alignment status comprises a positive value and a negative value. The communication unit is disposed/located in the foundation pad, and configured to transmit data to an external application. The foundation pad, the plurality of interchangeable layers, and the plurality of magnetic pegs together facilitate providing real-time feedback.

In some embodiments of the present disclosure, the foundation pad further comprises a processor that is configured to process the data associated with the detection of the placement of the plurality of magnetic pegs.

In some embodiments of the present disclosure, the foundation pad, the plurality of interchangeable layers, and the plurality of magnetic pegs provide real-time feedback based on the alignment status.

In some embodiments of the present disclosure, the communication unit is configured to transmit the data to the external application, enabling immediate tracking and recording of one or more interactions of a user.

In some embodiments of the present disclosure, the alignment status comprises a positive value when the plurality of magnetic pegs aligns with the corresponding plurality of cutouts.

In some embodiments of the present disclosure, the alignment status comprises a negative value when the plurality of magnetic pegs misaligns with the corresponding plurality of cutouts.

In some embodiments of the present disclosure, the interactive learning board system further includes customizable alphabet sheets disposed beneath the language layer, and configured to provide visual guidance for letter or symbol placement according to the language.

In some embodiments of the present disclosure, the foundation pad and the plurality of magnetic pegs work in conjunction to provide real-time feedback by way of detection of when a peg of the plurality of pegs is placed correctly or incorrectly; transmitting a feedback signal to the external application; and enabling the external application to display immediate feedback to the user such that the display indicates one of the correct placement of the plurality of magnetic pegs and incorrect placement of the magnetic pegs.

In some aspects of the present disclosure, a method for interactive learning of the alphabet of multiple languages is provided. The method comprising a step of providing a plurality of interchangeable layers such that each interchangeable layer corresponds to a language of the multiple languages; providing a plurality of cutouts such that each cutout corresponds to one of a letter or a symbol of the alphabet of the language. The method further comprising a step of facilitating, by way of an alignment mechanism, correct positioning within a cavity. The method further comprising a step of representing, by way of each peg of the plurality of magnetic pegs, the letter or the symbol. The method further comprising a step of detecting, by way of embedded sensors, the placement of the plurality of magnetic pegs on each interchangeable layer. The method further comprising a step of determining, by way of the embedded sensors, an alignment status of the plurality of magnetic pegs. The alignment status comprises a positive value and a negative value. The method further comprising a step of transmitting, by way of a communication unit disposed in the foundation pad, data to an external application. The foundation pad, the plurality of interchangeable layers, and the plurality of magnetic pegs together facilitate providing real-time feedback.

In some embodiments of the present disclosure, the method further comprising a step of recording and analysing user interactions on the external application such that the user interactions include a number of correct and incorrect placements of the plurality of magnetic pegs. The method further comprising a step of generating, by way of the processor, progress reports associated with the learning patterns of the user based on the recorded data. The learning patterns are associated with the learning of the language by the user. The method further comprising a step of adjusting, by way of the processor, one or more learning recommendations based on the learning patterns of the user.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a block diagram of an interactive learning board system, in accordance with an embodiment of the present disclosure.

FIG. 2A illustrates a perspective view of the interchangeable layer, in accordance with an embodiment of the present disclosure.

FIG. 2B illustrates a base layer for the interchangeable layer, in accordance with an embodiment of the present disclosure.

FIG. 3 illustrates a flowchart of a method for interactive learning of alphabet of multiple languages, in accordance with an embodiment of the present disclosure.

FIGS. 4A-4C illustrates various components of an interactive learning board system, in accordance with an embodiment of the present disclosure.

FIG. 4B illustrates various components (for example, numbers, shape etc.) of the interactive learning board system, in accordance with another embodiment of the present disclosure.

FIG. 5 illustrates a flowchart of a method for interactive learning of alphabet of multiple languages, in accordance with an embodiment of the present disclosure.

FIG. 6 illustrates an interactive alphabet board that uses sensors to detect user interactions with letter placements, in accordance with an embodiment of the present disclosure.

To facilitate understanding, like reference numerals have been used, where possible, to designate like elements common to the figures.

### DETAILED DESCRIPTION

Various aspects of the present disclosure provide an interactive learning board system and a method thereof. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this disclosure. Rather, the inventor/inventors have contemplated that the claimed subject matter might also be embodied in other ways, to include different features or combinations of features similar to the ones described in this document, in conjunction with other technologies. Generally, the various aspects including the example aspects relate to an interactive learning board system and a method thereof.

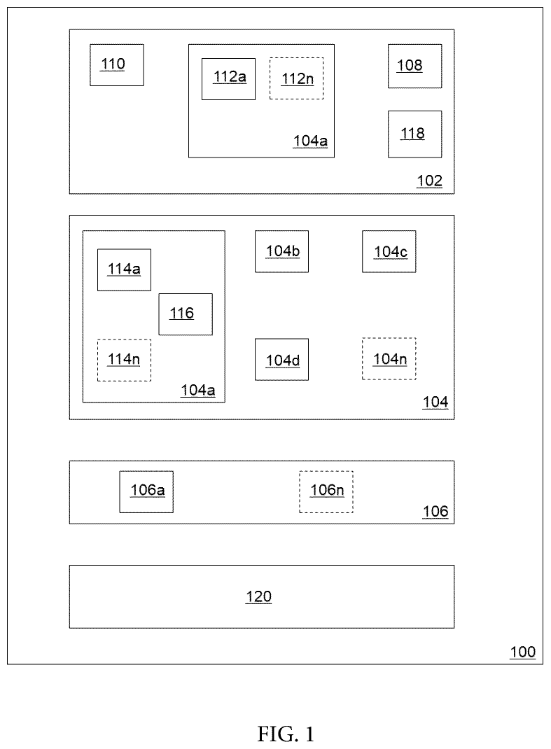

FIG. 1 illustrates a block diagram of an interactive learning board system 100, in accordance with an embodiment of the present disclosure. The interactive learning board system 100 (hereinafter referred to and designated as “the system 100”) may be configured to facilitate a user to learn multiple languages. Specifically, the system 100 may be configured to facilitate the user to learn alphabet of the multiple languages. The system 100 may be configured to facilitate learning of the multiple languages by the user. The system 100 may therefore be interactive tool to impart knowledge of the multiple languages to the user. The system 100 is a versatile educational tool designed to make language learning both fun and personalized while reducing the need for screen time. It features a durable, child-safe foundation pad that includes a magnetic sheet and a built-in storage compartment, which also serves as a whiteboard. The system comes with interchangeable language layers, each with precisely cut-out spaces for letters, numbers, or shapes, allowing users to easily switch between languages and educational content. Magnetic pegs, which correspond to the cut-outs, are embedded with magnets that securely attach to the magnetic sheet, ensuring a stable and interactive learning experience. This hands-on design encourages critical thinking, fosters cultural awareness, and enhances communication skills. The system 100 also incorporates advanced technology to enhance the learning experience. Through a complementary app, available on mobile devices, web browsers, or cloud platforms, users may create personalized content by capturing images or words from their environment or by using standard vocabulary. This content may be printed and placed under the language layers on the board and is stored in the cloud for easy access and updates. The board and magnetic pegs are equipped with sensors and chips that track the child's interactions, recording whether a peg is placed correctly or incorrectly. This data helps generate progress reports, providing valuable insights into the child's learning development. With the power of artificial intelligence, the app analyses these progress reports to identify learning gaps and deliver personalized content designed to address those areas. The app also offers interactive educational games that help reinforce the child's learning. By combining tactile, hands-on learning with technological innovation, the system 100 creates a flexible and personalized educational platform. It prepares children to thrive in a globalized world by nurturing their curiosity, promoting linguistic diversity, and developing essential skills in critical thinking and communication across multiple languages.

The system 100 may include a foundation pad 102, a plurality of interchangeable layers 104a-104n (hereinafter collectively referred to and designated as “the interchangeable layers 104”), a plurality of magnetic pegs 106a-106n (hereinafter collectively referred to and designated as “the magnetic pegs 106”), and a communication unit 108.

The foundation pad 102 may include a cavity 110, embedded sensors 112a-112n (hereinafter collectively referred to and designated as “the embedded sensors 112”). In some embodiments of the present disclosure, the foundation pad 102 may be made up of a material including, but not limited to, durable, lightweight, child-safe plastic resistant to wear and tear. Embodiments of the present disclosure are intended to include and/or otherwise cover any type of the material for the foundation pad 102, without deviating from the scope of the present disclosure. In some embodiments of the present disclosure, the foundation pad 102 may have a length that may be in a range of 300 millimetres (mm) to 320 mm, a width that may be in a range of 240 mm to 250 mm, and height that may be in a range of 5 mm to 15 mm. Preferably, the length of the foundation pad 102 may be 310 mm. The width of the foundation pad 102 may be 242 mm. The height of the foundation pad 102 may be 9 mm. The foundation pad 102 may have corners that may be rounded and thereby adding an extra safety to the user while the user deals with the system 100 to learn multiple languages. The foundation pad 102 may further include an upper surface that may feature a groove. The groove may facilitate to couple the interchangeable layers 104 on the foundation pad 102. The foundation pad 102 may further include embedded magnetic sheet that may have a length of 304 mm, a width of 216 mm, and a height of 1.5 mm. The magnetic sheet may be preferably made up of a metallic material. Embodiments of the present disclosure are intended to include and/or otherwise cover any ferrous material for the magnetic sheet. Preferably, the magnetic sheet may be made up of a metal plate that may be over-moulded such that the foundation pad 102 is disposed inside the magnetic sheet. The magnetic sheet facilitates coupling of the plurality of magnetic pegs 106 on the foundation pad 102. The foundation pad 102 may further include embedded electronics that may be equipped with a chip and sensors to detect placement of the plurality of magnetic pegs. The sensors and the chip may be powered by batteries and/or alternative power sources.

In some embodiments of the present disclosure, the system 100 may further include a storage compartment. The storage compartment may be disposed in front of the foundation pad 102. The storage compartment may be adapted to hold up to 5 interchangeable layers or activity sheets or alphabet sheets or numbers and shapes activity sheets. The storage compartment may be adapted to keep the sheets/interchangeable layers flat and crease-free with a user-friendly sliding mechanism. The storage compartment may facilitate to provide whiteboard functionality. The base of the storage compartment doubles as a whiteboard compatible with dry-erase markers, allowing for drawing or writing activities when the language layers are not attached.

Each interchangeable layer of the interchangeable layers 104 may correspond to a language of the multiple languages. Each interchangeable layer of the interchangeable layers 104 may include a plurality of cutouts 114a-114n (hereinafter collectively referred to and designated as “the cutouts 114”) and an alignment mechanism 116. Each cutout of the cutouts 114 may correspond to one of, a letter or a symbol of the alphabet of the language of the multiple languages. The alignment mechanism 116 may be configured to facilitate to correct positioning within the cavity 110. Each interchangeable layer of the interchangeable layers 104 may have a length that may be in a range of 300 mm to 320 mm, a width that may be in a range of 220 mm to 250 mm, and a height that may be in a range of 2 mm to 5 mm. Preferably, each interchangeable layer of the interchangeable layers 104 may have the length that may be 303 mm, the width that may be 240 mm, and the height that may be 3 mm. Each interchangeable layer of the interchangeable layers 104 may be made up of a durable and child safe plastic ABS plastic or other suitable child safe and environmentally sustainable material. Embodiments of the present disclosure are intended to include and/or otherwise cover any type of the material for each interchangeable layer of the interchangeable layers 104, without deviating from the scope of the present disclosure. The cutouts 114 may be precision-cut shapes for the letters, the numbers, or the symbols that may be specific to different languages or educational content. Each interchangeable layer of the interchangeable layers 104 may be attached in the system 100 by way of an attachment mechanism. The attachment mechanism may be a sliding mechanism wherein the edges are slightly modified to slide securely into the cavity of the foundation pad 102. The attachment mechanism may facilitate to provide stability to each interchangeable layer of the interchangeable layers 104. The language layer may remain firm, once each interchangeable layer of the interchangeable layers 104 is attached. The attachment mechanism may facilitate ease of use of the system or the interchangeable layers 104. The attachment mechanism may facilitate quick swapping between different language layers that may facilitate seamless transition between the languages and/or subjects.

Each magnetic peg of the magnetic pegs 106 may represent the letter or the symbol. The embedded sensors 112 may be configured to detect placement of the magnetic pegs 106 on each interchangeable layer. The embedded sensors 112 may be further configured to facilitate to determine an alignment status of the magnetic pegs 106. The alignment status comprising a positive value and a negative value. Each magnetic peg of the magnetic pegs 106 may have a length that may be in a range of 35 mm to 45 mm, a width that may be in a range of 35 mm to 45 mm, and a height that may be in a range of 2 mm to 5 mm. Preferably, each magnetic peg of the magnetic pegs 106 may have the length that may be 40 mm, the width that may be 40 mm, and the height that may be 3 mm. Each magnetic peg of the magnetic pegs 106 may be made up of a material including, but not limited to, non-toxic, child safe plastic material. Embodiments of the present disclosure are intended to include and/or otherwise cover any type of the material for each magnetic peg of the magnetic pegs 106, without deviating from the scope of the present disclosure. Each magnetic peg of the magnetic pegs may be shaped and sized such that it facilitates ergonomic usage of the system 100 by the user.

The communication unit 108 may be disposed in the foundation pad 102. The communication unit 108 may be configured to transmit data to an external application. The foundation pad 102, the interchangeable layers 104, and the magnetic pegs 106 may together facilitates to provide real-time feedback. In some embodiments of the present disclosure, the communication unit 108 may be one of, a wired communication unit or a wireless communication unit 108. Embodiments of the present disclosure are intended to include and/or otherwise cover any type of the communication unit 108, without deviating from the scope of the present disclosure.

In some embodiments of the present disclosure, the foundation pad 102 may further include a processor 118 that may be configured to process the data associated with the detection of the placement of the magnetic pegs 106.

In some embodiments of the present disclosure, the foundation pad 102, the interchangeable layers 104, and the magnetic pegs 106 may provide the real-time feedback based on the alignment status.

In some embodiments of the present disclosure, the communication unit 108 may be configured to transmit the data to the external application. The communication unit 108 may therefore be configured to facilitate to enable immediate tracking and recording of one or more interactions of a user.

In some embodiments of the present disclosure, the alignment status comprising the positive value when the magnetic pegs 106 aligns with the corresponding cutouts 114. In some embodiments of the present disclosure, the alignment status comprising the negative value when the magnetic pegs 106 misaligns with the corresponding cutouts 114.

In some embodiments of the present disclosure, the system 100 may further include customizable alphabet sheets 120 that are disposed beneath the interchangeable layer. The customizable alphabet sheets 120 may be configured to provide visual guidance for the letter or the symbol placement according to the language of the multiple languages.

In some embodiments of the present disclosure, the foundation pad 102 and the magnetic pegs 106 may work in conjunction to provide the real-time feedback by way of detection of when a peg of the magnetic pegs 106 is placed correctly or incorrectly. The processor 118 may be configured to generate a feedback signal that may be transmitted to the external application. This enables the external application to display immediate feedback to the user such that the display indicates one of, the correct placement of the plurality of magnetic pegs (106a-106n) and incorrect placement of the plurality of magnetic pegs (106a-106n).

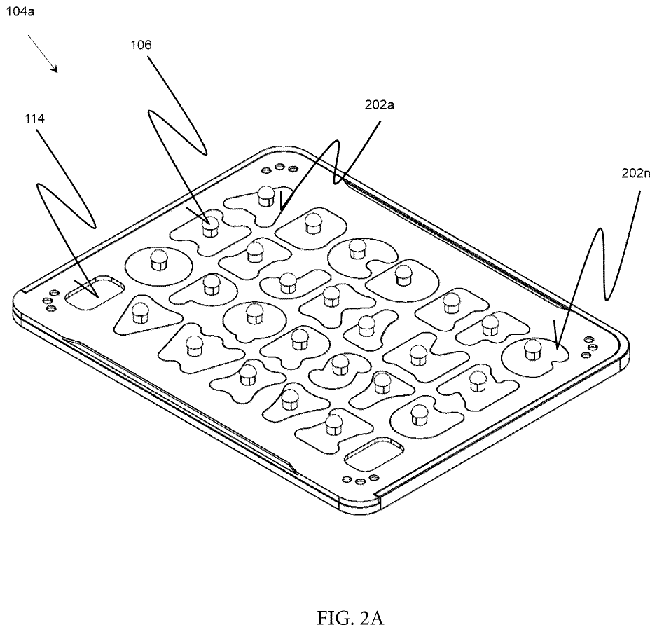

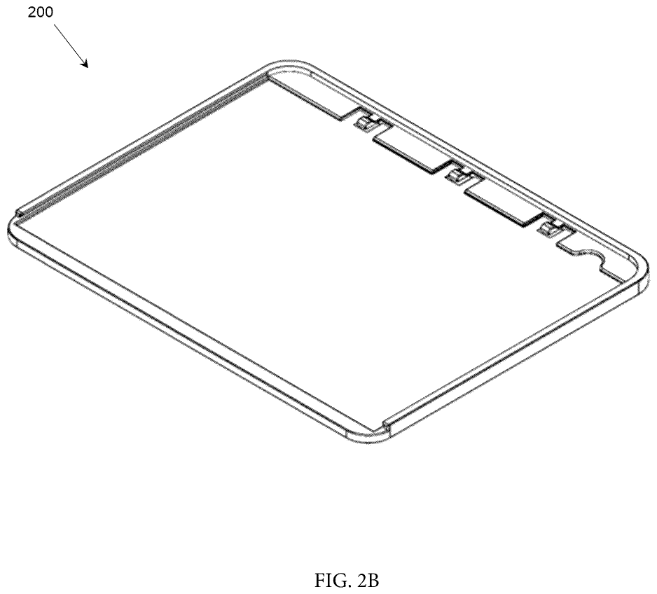

FIG. 2A illustrates a perspective view of the interchangeable layer 104a, in accordance with an embodiment of the present disclosure. FIG. 2B illustrates a base layer 200 for the interchangeable layer 104a, in accordance with an embodiment of the present disclosure.

The interchangeable layer 104a may be a language layer. The interchangeable layer 104a may represent the letters or the symbols 202a-202n (hereinafter collectively designated as “202”) such that the user can easily see or view the letters or the symbols 202 on the interchangeable layer 104a.

In some embodiments of the present disclosure, the letters or the symbols 202 may be engraved or etched in the interchangeable layer 104a. In some other embodiments of the present disclosure, the letters or the symbols 202 may be provided as cutouts in the interchangeable layer 104a. In some other embodiments of the present disclosure, the letters or the symbols 202 may be represented as protrusions on the interchangeable layer 104a. For example, as illustrated in FIG. 2A, the interchangeable layer 104a may represent an English language. Specifically, the letters or the symbols 202 may be English alphabets. In some other examples of the present disclosure, the interchangeable layer 104a may represent any other language.

The base layer 200 may be a backing layer for the interchangeable layer 104a. In other words, the base layer 200 may be adapted to support the interchangeable layer 104a in the system 100. Preferably, the base layer 200 may be adapted to provide a mechanical strength the interchangeable layers 104 in the system 100.

In some embodiments of the present disclosure, the base layer 200 and the interchangeable layer 104a may be made up of a same material. In some other embodiments of the present disclosure, the base layer 200 and the interchangeable layer 104a may be made up of different materials. Embodiments of the present disclosure are intended to include and/or otherwise cover any type of iteration for the same material and the different materials for the base layer 200 and the interchangeable layer 104a, without deviating from the scope of the present disclosure.

In some embodiments of the present disclosure, the base layer 200 and the interchangeable layer 104a may be made up of a material including, but not limited to, a plastic, a metal, an alloy, carbon-fiber, and the like. Embodiments of the present disclosure are intended to include and/or otherwise cover any type of the material for the base layer 200 and the interchangeable layer 104a, without deviating from the scope of the present disclosure.

The system 100 is an innovative educational tool that blends physical interaction with advanced digital technologies to provide personalized learning experiences. By integrating cloud computing and artificial intelligence (AI), the system adapts educational content to meet each learner's individual needs while tracking progress over time. This fusion of tangible, hands-on learning with digital applications offers an enhanced, dynamic educational experience that evolves with the child's development. A key feature of the system 100 is its content creation application, which allows users to generate personalized learning material. The application is accessible across multiple platforms, including mobile devices, web browsers, and cloud-based services, providing convenience and flexibility. Parents and educators can choose from a library of standard vocabulary and educational content or capture content from the child's environment, such as images, words, or sounds, to make the learning experience more engaging. Once created, this personalized content can be easily printed and placed on the system 100 board beneath the interchangeable language layers, ensuring that the board reflects the child's unique learning needs. Additionally, all content is securely stored in the cloud, enabling remote access and updates across devices, keeping the material current and easily accessible. Incorporating interactive educational games further enhances the system 100 learning experience. These games are specifically designed to develop language skills, critical thinking, and problem-solving abilities. By integrating both physical and digital elements, the games can be played interactively on the system 100 board, offering immediate digital feedback in response to physical actions. The system also provides adaptive learning experiences, where the games adjust in difficulty based on the child's progress, ensuring that challenges remain appropriate. Motivational elements such as rewards, badges, and progress tracking encourage continuous learning and achievement, making the educational process both fun and rewarding. The system 100 also features embedded sensors in both the foundation pad and the magnetic letter pegs, which work together to detect when a peg is placed correctly on the board. This real-time activity detection provides immediate feedback, ensuring that children receive instant reinforcement for correct responses and gentle guidance when mistakes are made. The data collected through these interactions is transmitted wirelessly to the application using Bluetooth or Wi-Fi, allowing for seamless communication between the physical and digital components. Efficient power management ensures that the system operates for extended periods without the need for frequent recharging, using either rechargeable batteries or energy-harvesting technologies. The learning progress of each child is meticulously tracked through the system's data collection and reporting capabilities. The application records details such as the frequency of correct and incorrect answers, time spent on activities, and overall progression. AI-powered analysis of this data generates detailed learning progress reports, identifying both strengths and areas that require improvement. Using this information, the system can offer personalized interventions, adjusting content to address specific learning gaps and challenges. The AI also assists in the creation of tailored content, ensuring that educational materials remain relevant and effective, evolving with the child's growing knowledge. Finally, the system 100 is designed to minimize screen time while still incorporating the benefits of technology. The primary interaction with the system remains physical, with the child manipulating the board and pegs, which encourages hands-on learning. The application operates in the background to track data and provide post-activity analysis without requiring direct screen engagement during learning sessions. Additionally, the system supports parental and educator involvement by offering detailed progress reports and AI-generated recommendations. This enables adults to customize the learning experience, adjusting difficulty levels, selecting content themes, and setting learning goals to align with the child's unique pace and evolving needs.

The system 100 may have following working examples as shown hereinbelow:

### WORKING EXAMPLES

### Example 1: Learning the English Alphabet

### Setup:

Language Layer: English alphabet layer with cutouts for A-Z.
Magnetic Pegs: A set of pegs corresponding to each English letter.
Application Content: Personalized content sheet featuring images and words starting with each letter.

### Activity:

1. Preparation: Using the application, create or select personalized content, then print and place it onto the Foundation Pad. Slide the English Language Layer over the content.
2. Interaction: The child selects magnetic pegs and matches them to the corresponding letter cutouts on the board.
3. Feedback: Embedded sensors detect when a peg is placed correctly, providing immediate feedback via the application or recording the data for later analysis.
4. Learning Reinforcement: As the child places each peg, they can pronounce the letter and associated words, boosting phonemic awareness and reinforcing letter-sound connections.

### Outcome:

Letter Recognition: The child learns the shapes and sounds of the English alphabet.
Fine Motor Skills: Handling the pegs helps develop dexterity and hand-eye coordination.
Personalized Learning: Tailored content keeps the child engaged, enhancing the learning process.

### Example 2: Switching to Hindi Language Learning

### Setup:

Language Layer: Hindi alphabet layer (Devanagari script) with cutouts for the letters.
Magnetic Pegs: A set of pegs for Hindi letters.
Application Content: Personalized content sheet with common Hindi words and images.

### Activity:

1. Transition: Remove the English language layer and replace it with the Hindi layer. Update the content sheet via the application to reflect the new language.
2. Interaction: The child matches Hindi magnetic pegs to the cutouts on the board.
3. Cultural Integration: Discuss the images and words on the content sheet, providing context for the Hindi language and its cultural significance.
4. Multilingual Exposure: Encourage the child to compare letters and sounds between English and Hindi, fostering language awareness and cross-linguistic connections.

### Outcome:

Multilingual Skills: The child gains exposure to Hindi, expanding their cognitive flexibility and language skills.
Cultural Awareness: Learning Hindi helps the child appreciate different cultural contexts and traditions.
Adaptability: The ability to switch languages easily keeps the child engaged and open to new learning challenges.

### Example 3: Utilizing the Whiteboard and Freeform Play

### Setup:

Foundation Pad: Used without any language layer attached.
Markers: Dry-erase markers suitable for the whiteboard surface.
Magnetic Pegs: Used to form 3-to 4-letter words and for creative arrangements.

### Activity:

1. Creative Expression: The child uses the whiteboard to draw pictures, write letters, or practice numbers, exploring different forms of expression.
2. Open-Ended Play: Magnetic pegs are freely arranged on the board to create patterns, words, or even stories, allowing for imaginative play.
3. Interactive Learning: Parents or educators can write prompts or questions on the whiteboard to encourage the child to respond or solve problems.
4. Game Play: Educational games such as tic-tac-toe or hangman are played using the magnetic pegs, making learning fun and interactive.

### Outcome:

Creativity Enhancement: The open-ended nature of the activities fosters artistic expression and imagination.
Critical Thinking: Problem-solving and planning skills are developed through interactive and freeform play.
Social Interaction: Collaborative play improves communication and social skills as children work together to create and learn.

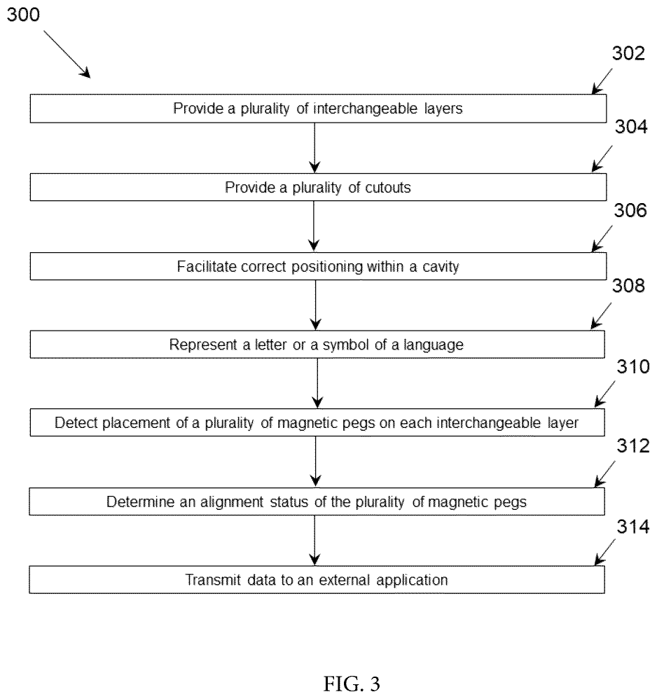

FIG. 3 illustrates a flowchart of a method 300 for interactive learning of alphabet of multiple languages. The method 300 may include following steps for interactive learning of alphabet of multiple languages.

At step 302, the system 100 may be configured to provide the plurality of interchangeable layers 104. Each interchangeable layer of the interchangeable layers 104 may correspond to a language of the multiple languages.

At step 304, the system 100 may be configured to provide a plurality of cutouts 114. Each cutout of the plurality of cutouts 114 may correspond to one of, a letter or a symbol of the alphabet of the language.

At step 306, the system 100 may be configured to facilitate correct positioning within the cavity 110. Specifically, the system 100, by way of the alignment mechanism 116, may be configured to facilitate correct positioning within the cavity 110.

At step 308, the system 100 may be configured to represent the letter or the symbol of the language of the multiple languages. Specifically, the system 100, by way of each peg of the plurality of magnetic pegs 106, may be configured to represent the letter or the symbol of the language of the multiple languages.

At step 310, the system 100 may be configured to detect the placement of the plurality of magnetic pegs 106 on each interchangeable layer. Specifically, the system 100, by way of the embedded sensors 112, may be configured to detect the placement of the plurality of magnetic pegs 106 on each interchangeable layer.

At step 312, the system 100 may be configured to determine the alignment status of the plurality of magnetic pegs 106. Specifically, the system 100, by way of the embedded sensors 112, may be configured to determine the alignment status of the plurality of magnetic pegs 106. The alignment status comprising the positive value and the negative value. The alignment status comprising the positive value when the plurality of magnetic pegs 106 aligns with the corresponding plurality of cutouts 114. The alignment status comprising the negative value when the plurality of magnetic pegs 106 misaligns with the corresponding plurality of cutouts 114.

At step 314, the system 100 may be configured to transmit the data to the external application. Specifically, the system 100, by way of the communication unit 108 disposed in the foundation pad 102, the data to the external application. The communication unit 108 may be the wired communication unit or the wireless communication unit. Embodiments of the present disclosure are intended to include and/or otherwise cover any type of the communication unit 108, without deviating from the scope of the present disclosure. The foundation pad 102, the plurality of interchangeable layers 104, and the plurality of magnetic pegs 106 may together facilitate to provide the real-time feedback.

In some embodiments of the present disclosure, the method 300 may further include a step of recording and analyzing. The system 100 may be configured to record and analyze the user interactions on the external application such that the user interactions include the number of correct and incorrect placement of the plurality of magnetic pegs 106. The method 300 may further include a step of generating progress reports. The system 100 may be configured to generate the progress reports associated with the learning patterns of the user. Specifically, the system 100, by way of the processor 118, may be configured to generate the progress reports associated with the learning patterns of the user based on the recorded data. The learning patterns may be associated with learning of the language by the user. The method 300 may further include a step of adjusting the recommendations. The system 100 may be configured to adjust the one or more learning recommendations based on the learning patterns of the user. Specifically, the system 100, by way of the processor 118, may be configured to adjust the one or more learning recommendations based on the learning patterns of the user.

In some embodiments of the present disclosure, the system 100 incorporates advanced hardware and software components to deliver a personalized, adaptive learning experience. On the hardware side, the system utilizes a range of technologies, including RFID, NFC, or capacitive touch sensors, to accurately detect peg placement on the board. Communication modules such as Bluetooth Low Energy (BLE) or Wi-Fi are integrated to ensure seamless data transmission to the associated application. Efficient power management features, including options for rechargeable batteries or low-power operation modes, ensure prolonged usage without frequent recharging.

In some embodiments of the present disclosure, the system 100 may be designed with a user-friendly interface, accessible via mobile devices, tablets, or web browsers. This makes it easy for both children and adults to navigate the system. Security and privacy are prioritized, with data encryption and secure authentication protocols in place to protect user information in compliance with privacy regulations. The system also incorporates artificial intelligence features, such as machine learning algorithms that analyse interaction data to identify patterns, predict learning outcomes, and adapt content accordingly. Additionally, natural language processing capabilities allow for more sophisticated content creation and interaction, particularly in text or speech-based applications.

The system 100 may facilitate third-party integration with educational platforms. Open APIs could allow developers to create additional applications or games compatible with the system, expanding its educational offerings. To enhance accessibility, features such as adaptive learning modes may be introduced, supporting learners with special educational needs by offering adjustable response times or alternative feedback methods. The system may also expand its multilingual support, catering to a global user base and ensuring inclusivity across different languages and cultural contexts. By integrating cutting-edge technology with hands-on interaction, the system 100 provides an innovative platform for early childhood education. The combination of embedded sensors, a versatile application, cloud storage, and AI analytics offers a sophisticated, yet intuitive tool for enhancing the learning process. The system not only supports children's development but also empowers parents and educators with valuable insights, making it a modern, effective solution for personalized, interactive learning experiences.

Thus, the system 100 advantageously addresses the shortcomings of existing educational technologies by offering several distinct advantages. First, it provides multilingual capability, allowing users to seamlessly switch between languages in seconds. This is achieved through its interchangeable language layers, making it a valuable tool for fostering multilingual learning. Additionally, the system supports personalized content creation, enabling customization to match each child's individual learning pace and interests. This is made possible by an application that allows users to create or capture content from the child's environment, reducing learning barriers and enhancing engagement. Furthermore, the system's interactive features, including the magnetic pegs and interchangeable layers, help keep the learning experience fresh and dynamic, preventing the stagnation often seen in static content-based puzzles. In addition to these key features, the system 100 promotes cultural awareness by introducing children to linguistic diversity from a young age. This exposure helps prepare them for global citizenship, fostering an appreciation for different cultures—a feature often missing in traditional educational toys. The system also offers a non-electronic, screen-free learning experience, unlike some alternatives that incorporate electronic components and increase screen time. The system 100 prioritizes hands-on learning while still incorporating technological advancements, such as embedded sensors and a companion application, to personalize the learning process without relying on screens.

By addressing these limitations, the system 100 offers a comprehensive and engaging educational tool that supports personalized, multilingual learning. It effectively combines the tactile benefits of traditional hands-on learning with the flexibility and customization enabled by modern technology. With embedded sensors, AI-powered applications, and customizable content sheets, the system 100 stands out as an innovative solution in the educational toy market, bridging the gap between physical and digital learning experiences.

The system 100 is designed to support multiple languages through its interchangeable language layers and customizable alphabet sheets including basic Arithmetic in some embodiments. Children can easily switch between languages, promoting multilingualism and preparing them for an interconnected global society. This flexibility helps children gain exposure to different languages, which is essential for cognitive and linguistic development. The system allows for unlimited customization via interchangeable alphabet sheets, which users can create using the application. Parents and educators can either capture content from the child's environment or use standard vocabulary. This content can be printed and stored in the cloud for remote access and updates. Customization ensures the learning material aligns with the child's interests, cultural background, or educational requirements based on various geographies, keeping the learning process engaging and relevant. The combination of magnetic pegs, embedded sensors, and customizable content creates a dynamic and interactive learning experience. As children interact with the system, their actions are recorded by the sensors and transmitted to the application, which provides instant feedback. This interactive design enhances engagement, making learning more enjoyable and helping children retain new information more effectively. The system 100 reduces negative emotions associated with learning by offering personalized content and an engaging, hands-on experience. Immediate feedback through the application helps children learn in a stress-free environment, lowering the affective filter—a psychological barrier that hinders language acquisition due to negative emotions such as boredom or anxiety. This allows children to absorb new information more easily and enjoyably. Through its customizable content and language support, the system 100 introduces children to multiple languages and cultures. It fosters cultural sensitivity and awareness by encouraging the exploration of diverse linguistic and cultural content. AI-powered educational games, tailored to reflect different cultures and languages, further enhance learning capabilities and prepare children to thrive in a globalized world. While the system 100 is primarily a physical, non-electronic tool, it integrates technology in a way that enhances learning without increasing screen time. The embedded sensors track interactions, while the companion application analyses progress and provides personalized interventions. This setup encourages healthier development by focusing on hands-on activities that improve fine motor skills and cognitive abilities, all while leveraging technology to personalize learning.

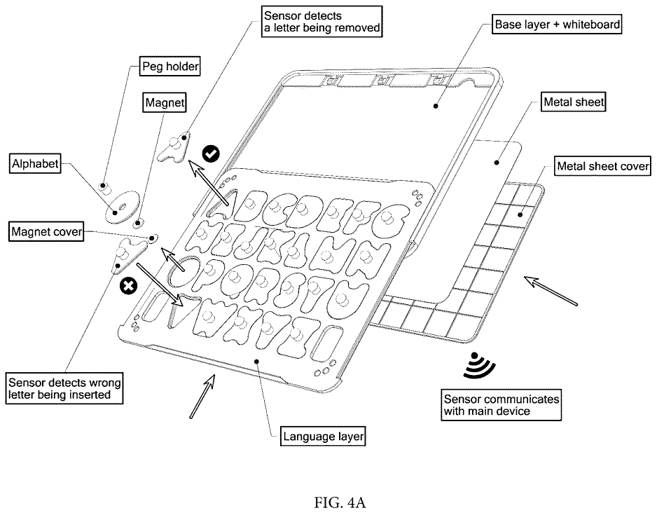

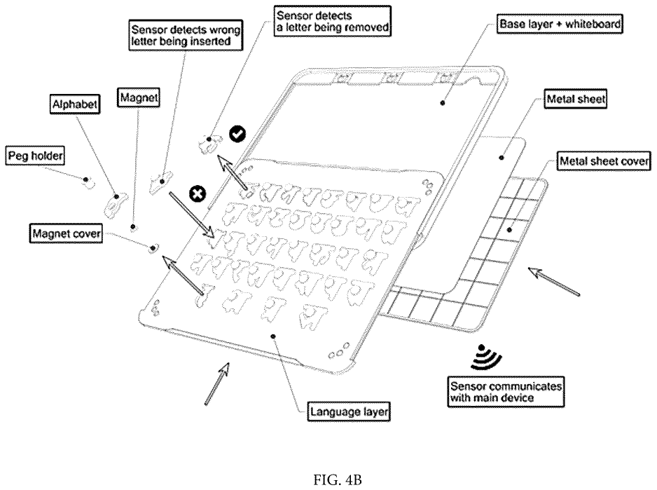

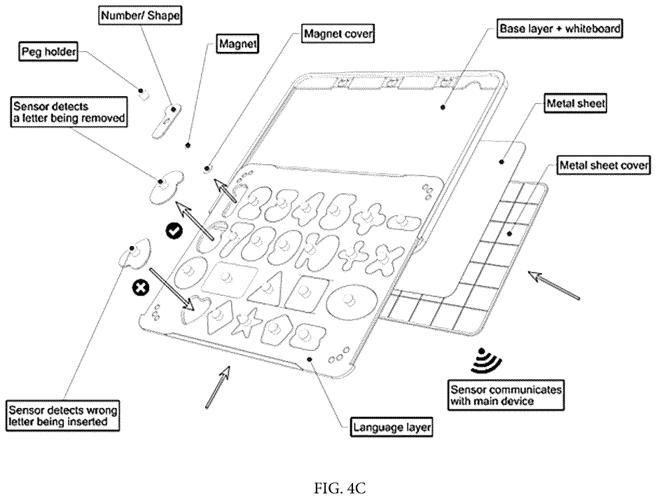

FIG. 4A illustrates various components of an interactive learning board system, in accordance with an embodiment of the present disclosure. FIG. 4A illustrates a smart, interactive alphabet board with a range of components designed for educational or training purposes.

### Components and Their Functions:

Alphabet: Represents the individual letter pieces that can be placed into or removed from the board.
Peg Holder: A component that holds the letter pieces securely in place on the board.
Magnet: Embedded in the alphabet pieces to allow them to adhere to the board and assist in sensor detection.
Magnet Cover: Protects the magnet within the alphabet piece to ensure safety and maintain functionality.
Language Layer: The surface where the alphabet pieces are placed, potentially marked with letter outlines to guide correct placement.
Base Layer+Whiteboard: The foundational layer of the board that may serve a dual purpose as a whiteboard for additional activities.
Metal Sheet: Positioned under the language layer, enabling magnetic adherence and interaction between the magnets and the sensors.
Metal Sheet Cover: A protective layer that encases the metal sheet to prevent exposure and maintain safety.
Sensor Detects a Letter Being Removed: A sensor system capable of identifying when an alphabet piece is removed, sending a signal to the main device for processing.
Sensor Detects Wrong Letter Being Inserted: A sensor that identifies incorrect placement of a letter and possibly triggers an alert or corrective response.
Sensor Communicates with Main Device: Indicates that the sensors are wirelessly or wiredly connected to a main processing device that records interactions and provides feedback.
Buzzer or Indicator (not explicitly labeled): Likely exists to provide audio or visual feedback when a correct or incorrect letter is placed or removed.
Explanation of the Working Mechanism: The system is designed to detect whether a letter is placed correctly or incorrectly using sensors and magnets. When a letter is removed, the sensor notes the change and communicates with the main device. If a wrong letter is placed, another sensor identifies this and can alert the user through feedback mechanisms (such as a buzzer). The magnet and metal sheet interaction ensure that the letter pieces adhere properly and that the sensors can detect their placement.

This interactive design can be used for educational purposes, helping users learn letter recognition and placement with immediate feedback.

FIG. 4B illustrates various components of the interactive learning board system, in accordance with another embodiment of the present disclosure. Specifically, FIG. 4B shows the perspective view of the interactive learning board system that facilitates to learn another language to the user. In some preferred embodiments of the present disclosure, FIG. 4B illustrates various components of the interactive learning board system that facilitates to learn Hindi Language to the user.

Since the interactive learning board system of FIG. 4B exhibits same or substantially similar structure and functionality to that of the interactive learning board system of FIG. 4A, therefore, for sake of brevity, the detailed description associated to FIG. 4B has not been provided herein.

FIG. 4C illustrates various components of the interactive learning board system, in accordance with another embodiment of the present disclosure. Specifically, FIG. 4C shows the perspective view of the interactive learning board system that facilitates to learn numeric digits and geometrical shapes to the user. In some preferred embodiments of the present disclosure, FIG. 4C illustrates various components of the interactive learning board system that facilitates to learn numeric digits from 0 to 10 of a numerical/mathematical system to the user.

Since the interactive learning board system of FIG. 4C exhibits same or substantially similar structure and functionality to that of the interactive learning board system of FIG. 4A, therefore, for sake of brevity, the detailed description associated to FIG. 4C has not been provided herein.

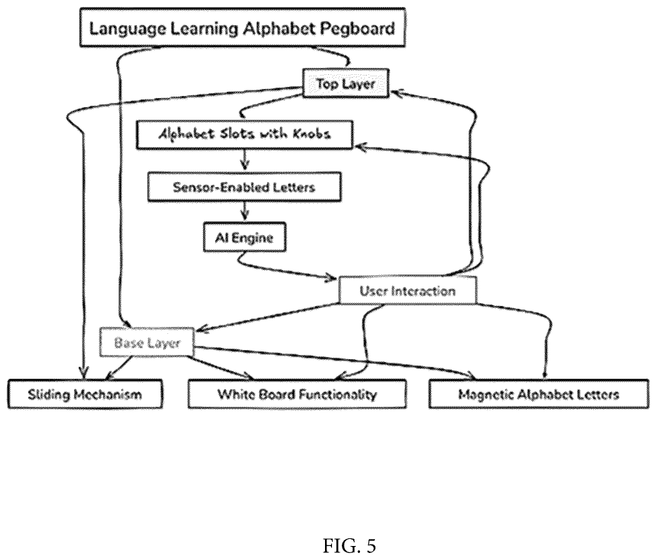

FIG. 5 illustrates a flowchart of a method for interactive learning of alphabet of multiple languages, in accordance with an embodiment of the present disclosure.

FIG. 5 shows a structured flow for a “Language Learning Alphabet Pegboard” system. Here's an explanation of the components and their interconnections.

### Main Components and Explanation:

Top Layer: The visible interface where the user interacts with the alphabet pieces. Connected to the Alphabet Slots with Knobs and Base Layer, serving as the main surface for user activities.
Alphabet Slots with Knobs: Individual slots designed to hold alphabet letters. Each slot includes a knob for easy placement and removal of letters. Directly interacts with Sensor-Enabled Letters, ensuring that letters are properly aligned and secured.
Sensor-Enabled Letters: Alphabet pieces embedded with sensors for detecting their placement and orientation. Connected to the AI Engine to send real-time data about user interactions.
AI Engine: A processing unit that receives data from Sensor-Enabled Letters and provides feedback or triggers user interaction functionalities. Plays a crucial role in monitoring and enhancing the learning experience by analyzing input and guiding users.
User Interaction: Represents the engagement of the user with the pegboard system, such as placing letters or using other features. Directly influenced by the AI Engine and interacts with the Top Layer and Base Layer.
Base Layer: The foundational layer that supports the overall structure of the pegboard and connects various components.

### Interfaces With the Sliding Mechanism, White Board Functionality, and Magnetic Alphabet Letters

### Supporting Components:

Sliding Mechanism: A feature that allows users to move or reposition parts of the pegboard, potentially for customization or storage. Connected to the Base Layer for physical support and integration.
White Board Functionality: Provides an additional surface for writing or drawing, enhancing the educational aspect of the pegboard. Tied to the Base Layer and Top Layer for ease of use.
Magnetic Alphabet Letters: Letters that are equipped with magnets for secure attachment to the board. Works in conjunction with the Alphabet Slots with Knobs and Sensor-Enabled Letters for proper placement and recognition, and also as letter components to form 3-4 letter words on magnetic white board for enhanced learning.
System Flow and Connectivity: The Top Layer houses the Alphabet Slots with Knobs, which interact with Sensor-Enabled Letters that feed data to the AI Engine. User Interaction is both influenced by and feeds into the AI Engine, creating a dynamic loop where feedback can guide further learning actions.

The base layer serves as the foundation that connects to the sliding mechanism, white board functionality, and magnetic alphabet letters to support versatile educational activities.

This setup is designed for interactive learning, using technology to make alphabet recognition and language learning more engaging and effective. The integration of sensors, an AI engine, and physical components allows for a comprehensive and interactive experience.

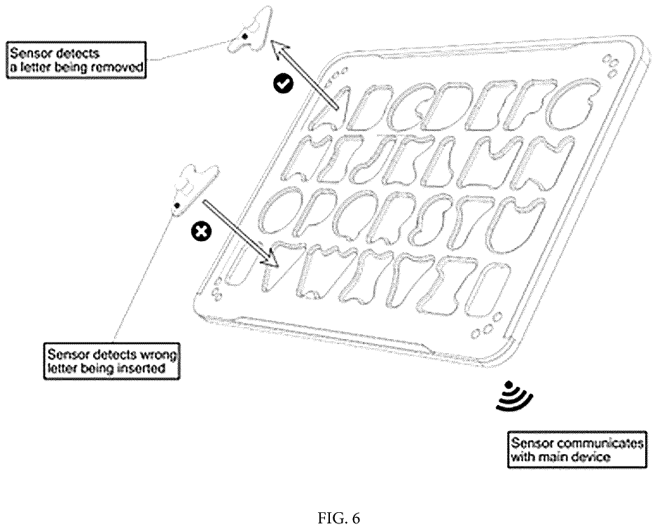

FIG. 6 illustrates an interactive alphabet board that uses sensors to detect user interactions with letter placements, in accordance with an embodiment of the present disclosure.

### Main Components and Labels:

Alphabet Pegboard: A board with slots for each letter of the alphabet. These slots are shaped according to the specific letters, ensuring that each letter fits into its designated spot.
Letter Pieces with Sensors: The individual alphabet pieces are equipped with embedded sensors that can detect whether they are placed correctly or incorrectly.

### Key Functional Features:

Sensor Detection for Removal: The board has a sensor system capable of detecting when a letter is removed from its slot. This is marked with a label in the drawing and is shown with a checkmark (√) symbol, indicating correct recognition of removal.
Sensor Detection for Incorrect Placement: The system can also detect if a letter is inserted into the wrong slot. This feature is crucial for guiding users in placing the correct letter in its appropriate spot. It is represented with an X symbol ( [symbol] ) to indicate that the wrong letter has been inserted.
Communication with Main Device: The board is equipped with technology that allows it to communicate wirelessly with a main device, such as a computer, tablet, or smartphone. This connection likely facilitates interactive feedback, such as auditory or visual cues for the user, and helps in recording data on user performance.

### Workflow Explanation:

Correct Placement Detection: When a letter is placed correctly in its slot, the sensor confirms this, and feedback can be provided through the main device to encourage or confirm the user's action.
Incorrect Placement Warning: If a user tries to place a letter in the wrong slot, the sensor detects the error, and a warning can be triggered to help the user correct their mistake.
Letter Removal: The board can also track when a letter is taken out of a slot, providing a way to monitor user interactions and adapt learning activities accordingly.
Applications and Educational Benefits: This type of interactive board is likely used for educational purposes, such as helping children or language learners with alphabet recognition and placement. The system offers immediate feedback, which helps reinforce correct learning and encourages self-correction.

In summary, this drawing shows a smart, sensor-equipped alphabet pegboard that interacts with users, detects correct and incorrect placements, and communicates with a main device for a comprehensive and engaging learning experience.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. An interactive learning board system (100) for learning alphabet of multiple languages, the interactive learning board system (100) comprising:
an foundation pad (102) comprising:
a cavity (110); and
embedded sensors (112a-112n);
a plurality of interchangeable layers (104a-104n) such that each interchangeable layer corresponds to a language of the multiple languages, and comprising:
a plurality of cutouts (114a-114n) such that each cutout correspond to one of, a letter or a symbol of the alphabet of the language;
an alignment mechanism (116) configured to facilitate to correct positioning within the cavity (110);
a plurality of magnetic pegs (106a-106n) such that each peg represents the letter or the symbol, wherein the embedded sensors (112a-112n) configured to detect placement of the plurality of magnetic pegs (106a-106n) on each interchangeable layer, wherein the embedded sensors (112a-112n) further configured to facilitate to determine an alignment status of the plurality of magnetic pegs (106a-106n), wherein the alignment status comprising a positive value and a negative value; and
a communication unit (108) disposed in the foundation pad (102), and configured to transmit data to an external application, wherein the foundation pad (102), the plurality of interchangeable layers (104a-104n), and the plurality of magnetic pegs (106a-106n) together facilitates to provide real-time feedback.

2. The interactive learning board system (100) as claimed in claim 1, wherein the foundation pad (102) further comprising a processor (118) that is configured to process the data associated with the detection of the placement of the plurality of magnetic pegs (106a-106n).

3. The interactive learning board system (100) as claimed in claim 1, wherein the foundation pad (102), the plurality of interchangeable layers (104a-104n), and the plurality of magnetic pegs (106a-106n) provide the real-time feedback based on the alignment status.

4. The interactive learning board system (100) as claimed in claim 1, wherein the communication unit (108) is configured to transmit the data to the external application and enabling immediate tracking and recording of one or more interactions of a user.

5. The interactive learning board system (100) as claimed in claim 1, wherein the alignment status comprising the positive value when the plurality of magnetic pegs (106a-106n) aligns with the corresponding plurality of cutouts (114a-114n).

6. The interactive learning board system (100) as claimed in claim 1, wherein the alignment status comprising the negative value when the plurality of magnetic pegs (106a-106n) misaligns with the corresponding plurality of cutouts (114a-114n).

7. The interactive learning board system (100) as claimed in claim 1, further comprising customizable alphabet sheets (120) disposed beneath the interchangeable layer, and configured to provide visual guidance for the letter or the symbol placement according the language of the multiple languages.

8. The interactive learning board system (100) as claimed claim 1, wherein the foundation pad (102) and the plurality of magnetic pegs (106a-106n) work in conjunction to provide the real-time feedback by way of detection of when a peg of the plurality of magnetic pegs (106a-106n) is placed correctly or incorrectly; transmitting a feedback signal to the external application; and enabling the external application to display immediate feedback to the user such that the display indicates one of, the correct placement of the plurality of magnetic pegs (106a-106n) and incorrect placement of the magnetic pegs (106a-106n).

9. A method (300) for interactive learning of alphabet of multiple languages, the method (300) comprising:
providing (302) a plurality of interchangeable layers (104a-104n) such that each interchangeable layer corresponds to a language of the multiple languages;
providing (304) a plurality of cutouts (114a-114n) such that each cutout correspond to one of, a letter or a symbol of the alphabet of the language;
facilitating (306), by an alignment mechanism (116), correct positioning within a cavity (110);
representing (308), by each peg of the plurality of magnetic pegs (106a-106n), the letter or the symbol,
detecting (310), by embedded sensors (112a-112n), placement of the plurality of magnetic pegs (106a-106n) on each interchangeable layer;
determining (312), by the embedded sensors (112a-112n), an alignment status of the plurality of magnetic pegs (106a-106n), wherein the alignment status comprising a positive value and a negative value; and
transmitting (314), by a communication unit (108) disposed in the foundation pad (102), data to an external application, wherein the foundation pad (102), the plurality of interchangeable layers (104a-104n), and the plurality of magnetic pegs (106a-106n) together facilitates to provide real-time feedback.

10. The method (300) as claimed in claim 9, further comprising:
recording and analysing user interactions on the external application such that the user interactions includes a number of correct and incorrect placement of the plurality of magnetic pegs (106a-106n);
generating, by way of the processor (118), progress reports associated with learning patterns of the user based on the recorded data, wherein the learning patterns is associated with learning of the language by the user; and
adjusting, by way of the processor (118), one or more learning recommendations based on the learning patterns of the user.
